(19) United States
(12) Patent Application Publication
(10) Pub. No.: US 2013/0119866 A1
(43) Pub. Date: May 16, 2013

(54) Luminaire and Lighting Method

(71) Applicants: Ryotaro Matsuda, Yokosuka-shi (JP); Sadao Sakaguchi, Yokosuka-shi (JP); Noriyuki Kitamura, Yokosuka-shi (JP)

(72) Inventors: Ryotaro Matsuda, Yokosuka-shi (JP); Sadao Sakaguchi, Yokosuka-shi (JP); Noriyuki Kitamura, Yokosuka-shi (JP)

(73) Assignee: TOSHIBA LIGHTING & TECHNOLOGY CORPORATION, Yokosuka-shi (JP)

(21) Appl. No.: 13/600,283

(22) Filed: Aug. 31, 2012

(30) Foreign Application Priority Data
Nov. 16, 2011 (JP) 2011-250675

(51) Int. Cl. H05B 33/02

(52) U.S. Cl. 315/112; 313/22

(57) ABSTRACT

According to one embodiment, a luminaire includes a light source that generates heat, a dome inside of which the light source is accommodated, and a globe covering the light source through the dome. At least part of the dome and at least part of the globe are translucent or transparent. A liquid is sealed in a space formed between the dome and the globe.

### CROSS-REFERENCE TO RELATED APPLICATIONS

This application is based upon and claims the benefit of priority from Japanese Patent Application No. 2011-250675, filed Nov. 16, 2011, the entire contents of which are incorporated herein by reference.

### FIELD

Embodiments described herein relate generally to a luminaire, such as a bulb-type LED lamp, including a light-emitting module in which a semiconductor light-emitting element such as an LED (Light Emitting Diode) is mounted on a board, and a lighting method.

### BACKGROUND

In general, a bulb-type LED lamp includes a light-emitting module in which an LED is mounted on a board, a thermal radiator which the light-emitting module contacts and is attached to, and a translucent globe covering a light extracting side of the light-emitting module. The light emitted from the light-emitting module passes through the globe and is used as an illumination light. The heat generated from the light-emitting module is radiated through the thermal radiator.

In order to enhance the light output of the foregoing bulb-type LED lamp of the related art, the thermal radiation property of the light-emitting module is required to be enhanced, and the size (surface area) of the thermal radiator is required to be made large to a certain degree. On the other hand, since the size of the bulb is substantially determined by the standard, if the size of the thermal radiator is made large, the size of the globe becomes small by that, and a luminous intensity distribution characteristic is influenced.

Thus, development is desired for a luminaire and a lighting method in which the thermal radiation property can be enhanced, the light output can be sufficiently enhanced, and a desired luminous intensity distribution characteristic can be obtained.

A conventional lamp is disclosed, for example, in WO2011/0974486.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an outer appearance perspective view showing a bulb-type LED lamp of an embodiment.

FIG. 2 is a sectional view in which the LED lamp of FIG. 1 is cut along a tube axis.

FIG. 3 is an exploded perspective view in which the LED lamp of FIG. 1 is decomposed into plural components.

FIG. 4 is a sectional view in which the LED lamp of FIG. 1 is decomposed into plural components.

FIG. 5 is a view showing the heat distribution of the LED lamp of FIG. 1.

FIG. 6 is a view showing the heat distribution of a case where water sealed in the enclosed space of the LED lamp of FIG. 1 is removed.

### DETAILED DESCRIPTION

In general, according to one embodiment, a luminaire includes a light source that generates heat, a dome inside of which the light source is accommodated, and a globe covering the light source through the dome. At least part of the dome and at least part of the globe are translucent or transparent. A liquid is sealed in a space formed between the dome and the globe.

Various embodiments will be described hereinafter with reference to the accompanying drawings.

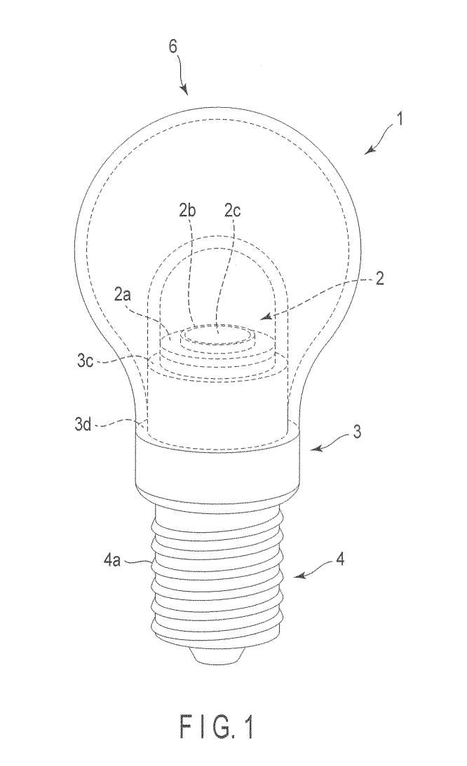

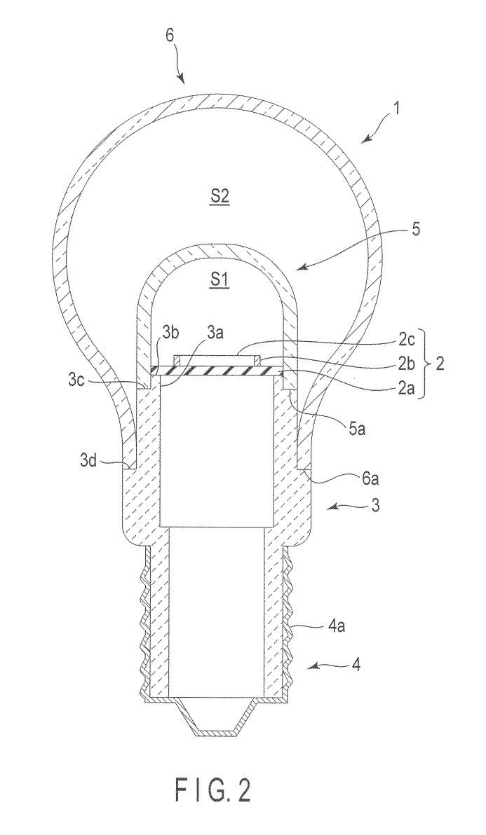

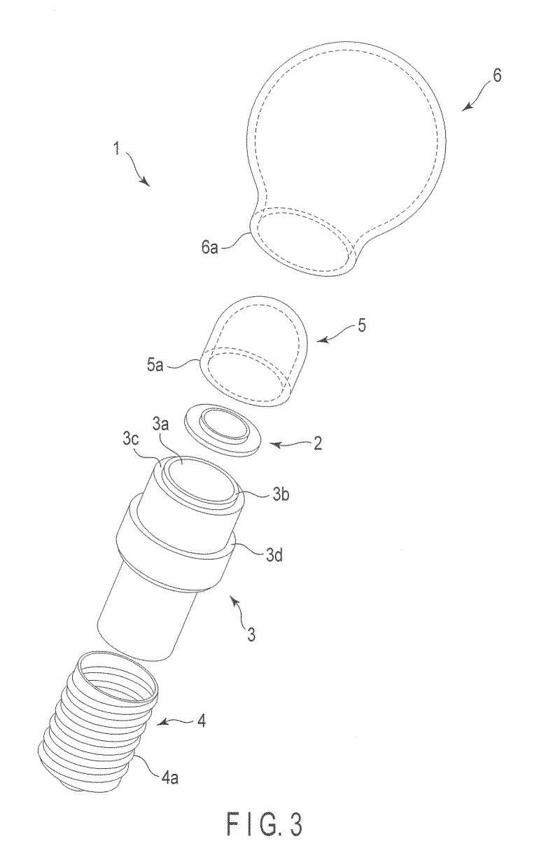

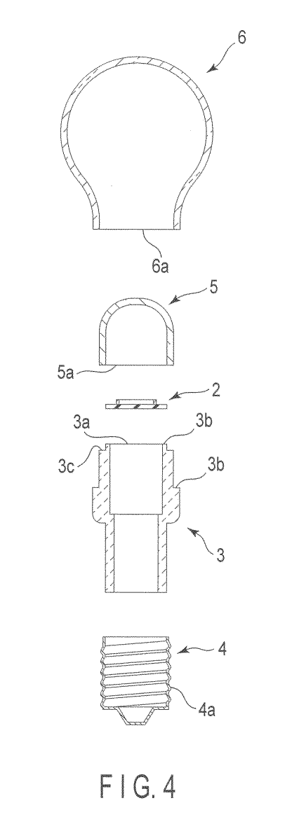

FIG. 1 is an outer appearance perspective view of a bulb-type LED lamp 1 as a luminaire of an embodiment. FIG. 2 is a sectional view in which the LED lamp 1 is cut along a tube axis. FIG. 3 is an exploded perspective view in which the LED lamp 1 is decomposed into plural components. FIG. 4 is a sectional view of the decomposed LED lamp 1.

The LED lamp 1 includes a light-emitting module 2, a thermal radiation case 3, a cap 4, an inside dome 5 and a globe 6. The LED lamp 1 is electrically and mechanically connected to a not-shown luminaire main body by screwing the cap 4 to a not-shown socket of the luminaire main body.

As shown in FIG. 1 and FIG. 2, the light-emitting module 2 is constructed such that not-shown plural LED (Light Emitting Diode) chips are mounted on the surface of a circular board 2a and are connected to the board, and then, an annular frame 2b surrounding the plural LED chips is provided, and a sealing resin 2c is filled in the frame 2b. A solid light-emitting element such as an organic EL element may be used as a light-emitting element instead of the LED chips.

The board 2a is constructed such that for example, an insulating layer is formed on the surface of a metal base, and a wiring pattern and a reflecting layer are formed thereon. The LED chips are, for example, blue LEDs to emit blue light, are attached onto the reflecting layer on the surface of the board 2a, and are respectively connected to the wiring pattern. The LED chips may be flip-chip mounted on the board.

The sealing resin 2c contains phosphor to excite and emit yellow light, which is complementary color of blue, by the blue light. That is, the blue light emitted from the LED chip mixes with the yellow light excited and emitted by the phosphor and a nearly while light is emitted from the light-emitting module 2. The light-emitting color of the light-emitting module 2 can be adjusted by changing the LED chip and/or the sealing resin 2c.

The thermal radiation case 3 is made of ceramic having substantially a cylindrical shape with a hollow inside. In addition to this, a metal having high heat conductivity, such as aluminum, may be used as the material of the thermal radiation case 3.

A not-shown circuit board on which a power supply circuit for feeding DC current to the plural LED chips of the light-emitting module 2 and not-shown plural electronic parts constituting a lighting circuit are mounted is accommodated and arranged in the hollow inside of the thermal radiation case 3. The circuit board contacts the thermal radiation case 3 and is attached, and is electrically connected to the board 2a of the light-emitting module 2. That is, the heat of the circuit board is conducted to the thermal radiation case 3.

A circular opening 3a at an illustrated upper end of the thermal radiation case 3 is blocked by the board 2a of the light-emitting module 2. In other words, an annular board mount surface 3b in contact with a back side peripheral edge of the board 2a of the light-emitting module 2 is formed at the illustrated upper end of the thermal radiation case 3. The outer diameter of the board mount surface 3b is substantially equal to the diameter of the board 2a of the light-emitting module 2. The heat of the light-emitting module 2 is conducted to the thermal radiation case 3 through the annular board mount surface 3b.

An annular inside shoulder part 3c for attachment of the inside dome 5 is formed on the outside of the board mount surface 3b. The inside shoulder part 3c is positioned below the board mount surface 3b in the drawing. Besides, an annular outside shoulder part 3d for attachment of the globe 6 is formed on the outside of the thermal radiation case 3 and at a position downwardly spaced from the inside shoulder part 3c in the drawing.

That is, the outer diameter of the inside shoulder part 3c is larger than the outer diameter of the board mount surface 3b, and the outer diameter of the outside shoulder part 3d is larger than the outer diameter of the inside shoulder part 3c. Thus, a double-tube structure is obtained in which the globe 6 is arranged outside the inside dome 5 as described later.

Further, a portion of the thermal radiation case 3 below the outside shoulder part 3d in the drawing is made to have a small diameter for attachment of the cap 4. Besides, this portion is made to have a helical concavo-convex shape (not shown) corresponding to a screw 4a of the cap 4. The cap 4 has the screw thread 4a for screwing into a not-shown socket on an equipment side. The cap 4 is electrically connected to the circuit board.

The inside dome 5 includes, at an illustrated lower end, an annular opening fringe part 5a which is in close contact with the inside shoulder part 3c of the thermal radiation case 3. The inside dome 5 is fixed to the thermal radiation case 3 by airtightly bonding the opening fringe part 5a to the inside shoulder part 3c of the thermal radiation case 3. In this state, the light-emitting module 2 mounted on the board mount surface 3b of the thermal radiation case 3 is surrounded and covered by the inside dome 5 and is hermetically sealed.

The inside dome 5 is made of, for example, glass, and includes a diffusing agent for diffusing light emitted from the light-emitting module 2.

Alternatively, the inside dome 5 is made of frosted glass. That is, the inside dome 5 itself functions as a light-emitting part to emit light. Thus, a portion of the inside dome 5 close to an illustrated upper end extends to at least the center of the globe 6 which is described later. Incidentally, a space S1 in which the inside dome 5 covers the light-emitting module 2 has an atmospheric pressure.

The globe 6 is made of, for example, glass, has an outer shape close to a sphere, and has an annular opening fringe part 6a at an illustrated lower end. A portion of the globe 6 close to the illustrated lower end has a shape gently converging to the opening fringe part 6a. The opening diameter of the opening fringe part 6a is slightly larger than the outer diameter of the inside dome 5.

The globe 6 is separated from the outside of the inside dome 5 and covers the inside dome so as to surround the inside dome 5, and is fixed to the thermal radiation case 3 by airtightly bonding the opening fringe part 6a to the outside shoulder part 3d of the thermal radiation case 3. Alternatively, the inside dome 5 and the globe 6 may be formed as one body.

In either case, a space outside the inside dome 5 and inside the globe 6 forms an airtight enclosed space S2. The enclosed space S2 contacts a part of the thermal radiation case 3, that is, an outer peripheral surface between the inside shoulder part 3c and the outside shoulder part 3d. In other words, the LED lamp 1 of the embodiment is designed such that the part of the thermal radiation case 3 is exposed to the enclosed space S2.

The enclosed space S2 is evacuated and is decompressed, and a small amount of water is sealed. For example, the enclosed space S2 is decompressed to such a pressure that water vaporizes at about 60° C. As a liquid to be sealed in the enclosed space S2, in addition to water, any liquid may be used as long as the liquid has translucency and vaporizes at a temperature of about 60° C. when the decompression is carried out. However, water is the most suitable liquid in which a state change from liquid to gas or from gas to liquid is easily controlled and which is easily handled and has translucency.

In this embodiment, water of 0.1 ml was sealed in the enclosed space S2 with a volume of 12.5 ml, and the enclosed space S2 was decompressed to 150 Torr. This pressure is the pressure at which water is boiled at 60° C. in a state where water vapor is generated in the enclosed space S2. In this case, for example, a glass pipe (not shown) is connected to an illustrated upper end of the globe 6, the enclosed space S2 is evacuated through the glass pipe, and simultaneously, a suitable amount of water is made to flow into the enclosed space S2. Then, the glass pipe is cut and the connection place is sealed.

The pressure in the enclosed space S2 is desirably a pressure at which the sealed liquid vaporizes at about 60 to 70° C. For example, when water is used as the liquid, the pressure is made about 150 Torr in order to vaporize water at 60° C., and the pressure is made about 235 Torr in order to vaporize water at 70° C.

Hereinafter, the thermal radiation function of the LED lamp 1 having the foregoing structure will be described.

When electric power is fed to the LED lamp 1 from the luminaire main body (not shown) through the cap 4 and the light-emitting module 2 is lit, the heat of the light-emitting module 2 is conducted to the thermal radiation case 3 through the board 2a. At the same time, the heat of the circuit board (not shown) contained in the thermal radiation case 3 is also conducted to the thermal radiation case 3. That is, when the LED lamp 1 is lit, the thermal radiation case 3 is gradually heated with time.

The heat conducted to the thermal radiation case 3 is radiated to the atmosphere through the thermal radiation case 3 itself, and heats the water in the enclosed space S2 to which the part of the thermal radiation case 3 is exposed. In this embodiment, since the size of the thermal radiation case 3 is relatively small, the ratio of the amount of heat for heating the water is large for that. By this, the heat of the light-emitting module 2 is absorbed and cooling is performed, and the heat of the electronic parts mounted on the not-shown circuit board is absorbed and cooling is performed.

The water heated in the enclosed space S2 vaporizes at a temperature corresponding to the pressure in the enclosed space S2. That is, if the pressure in the enclosed space S2 is the atmospheric pressure, the water is boiled at about 100° C. and vaporizes. If the enclosed space S2 is decompressed, the boiling point of water becomes low. In this embodiment, since the enclosed space S2 is decompressed to such a pressure that water boils at about 60° C., the water vaporizes at about 60° C. in the enclosed space S2. Incidentally, in this case, the pressure in the enclosed space S2 is set to such a pressure that water boils at a temperature of about 60° C. in a state where water vapor is generated in the enclosed space S2.

The water vaporized in the enclosed space S2, that is, water vapor spreads in the enclosed space S2 and reaches the inner surface of the globe 6, and reaches the outer surface of the inside dome 5. Since the inside of the inside dome 5, that is, the space S1 in which the light-emitting module 2 is attached has a relatively high temperature by heat generation of the light-emitting module 2, the heat of the water vapor is hardly conducted to the inside dome 5.

On the other hand, since the outside of the globe 6 is opened to the atmosphere and has an ambient temperature, it is estimated that the temperature is significantly lower than at least 60° C. That is, the water vapor reaching the inner surface of the globe 6 is liquefied by the temperature difference from the ambient temperature. At this time, heat is conducted to the globe 6 from the water vapor, and the globe 6 is heated. That is, in this case, the globe 6 functions as a thermal radiator.

The heat conducted to the globe 6 in this way is radiated to the atmosphere from the outer surface. The water liquefied on the inner surface of the globe 6 is again heated by the heat conducted from the thermal radiation case 3, and again vaporizes at the time point when the temperature reaches 60° C. That is, the water in the enclosed space S2 quickly changes the state between gas and liquid and is circulated, and conducts the heat of the light-emitting module 2 and the not-shown electronic parts to the globe 6.

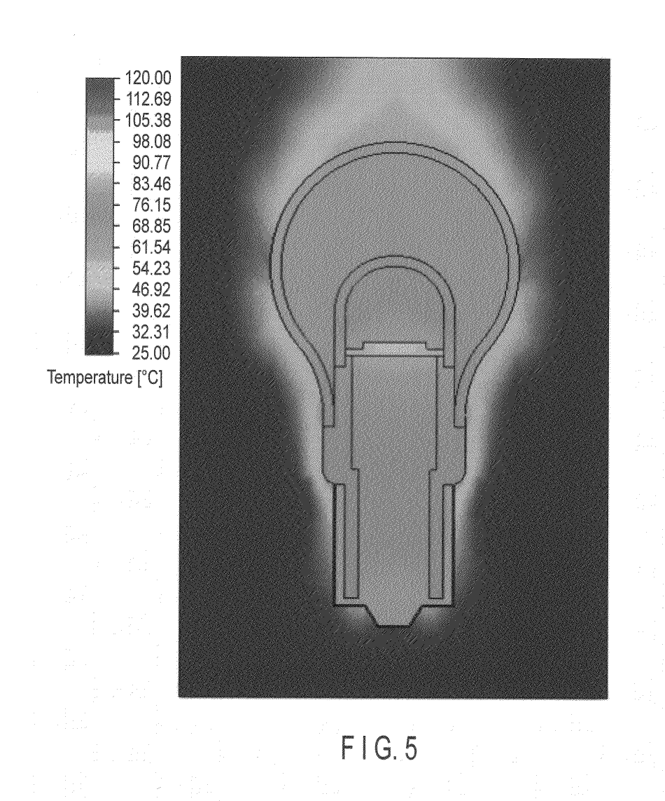

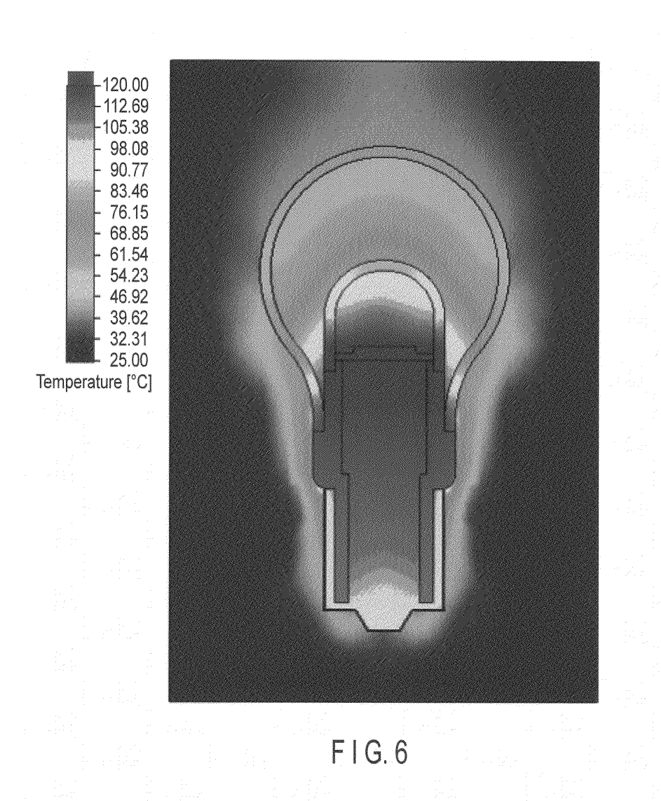

FIG. 5 shows a heat distribution of the LED lamp 1 in a state where heat is saturated after the LED lamp 1 is lit and some time passes. For comparison, FIG. 6 shows a heat distribution of the LED lamp 1 in a case where the water sealed in the enclosed space S2 is removed.

According to the LED lamp 1 of the embodiment shown in FIG. 5, it is understood that the whole is cooled to about 70° C. except that the light-emitting module 2 has a rather high temperature (about 80° C.) Especially, in this embodiment, it is understood that the globe 6 functions well as a thermal radiator. On the other hand, in the comparative example of FIG. 6, it is understood that only the thermal radiation case 3 has a high temperature significantly exceeding 100° C., and the light-emitting module 2 is hardly cooled. That is, in the example (the case where water is not sealed) of FIG. 6, the size of the thermal radiation case 3 is insufficient, and the use life of the light-emitting module 2 is expected to become short.

As stated above, according to the embodiment, since a small amount of water is sealed in the enclosed space S2 between the inside dome 5 and the globe 6 and decompression is carried out, heat can be well conducted to the globe 6 by using the latent heat effect of water, and the globe 6 having a relatively large surface area can be made to function as a thermal radiator. Thus, for example, as shown in FIG. 5, the whole LED lamp 1 can be effectively cooled, and the thermal radiation property of the light-emitting module 2 can be enhanced. Especially, according to the embodiment, in the state where the temperature of the light-emitting module 2 is saturated, the temperature is suppressed to about 80° C. and there is no fear that a bad influence is exerted on the use life.

Besides, according to the embodiment, since the globe 6 can be made to function as the thermal radiator, the thermal radiation case 3 is not required to be made larger than necessary unlike the related art, and the degree of freedom of design can be enhanced. Thus, according to the embodiment, the size and shape of the globe 6 can also be freely designed, a desired luminous intensity distribution characteristic can be easily obtained, and good illumination light can be provided.

Besides, in this embodiment, since the double-tube structure is adopted in which the inside dome 5 covering the light-emitting module 2 is arranged inside the globe 6, light passing through the inside dome 5 can be diffused, and excellent light with less unevenness can be emitted. Besides, since the inside dome 5 is provided, the same effect as that obtained by arranging a light source at the center of the globe 6 can be obtained, uniform light can be emitted in all directions, and the luminous intensity distribution can be widened.

Incidentally, in this embodiment, the inside dome 5 is attached in the globe 6, water is sealed in the enclosed space S2 between the globe 6 and the inside dome 5, and the decompression is carried out. However, the inside dome 5 is not an inevitable component, and may be omitted according to conditions. That is, the inside dome 5 is omitted, and the whole space in the globe 6 can be made one enclosed space S (that is, S1+S2).

In this case, since the water sealed in the enclosed space S directly acts on the light-emitting module 2, the light-emitting module 2 is required to be made completely waterproof. As stated above, when the inside dome 5 is omitted, heat generated from the light-emitting module 2 can be directly conducted to the globe 6, and the thermal radiation property can be further enhanced. Besides, naturally, an apparatus structure can be simplified by the omission of the inside dome 5, and the manufacturing cost can be reduced.

Further, in the embodiment, although the direction of the LED lamp 1 is not described, the LED lamp 1 of the embodiment can be attached and used in any direction. For example, when the LED lamp is used in the illustrated direction (the cap 4 is downward), since the water in the enclosed space S2 is liable to be collected in a state of contact with the exposed part of the thermal radiation case 3, the water is easily heated and vaporized.

On the other hand, when the LED lamp 1 is used in the reversed direction (the cap 4 is upward), the water in the enclosed space S is supposed to be collected at the top of the globe 6 by gravity. However, in the LED lamp 1 of the embodiment, as is described by use of FIG. 5, since the whole lamp can be controlled to have uniform temperature, the water can be vaporized irrespective of a place where the water contacts the lamp, and the thermal radiation function can be made operated under the same condition irrespective of the direction of the lamp.

According to the luminaire of the embodiment as described above, since the liquid is sealed in the space S2 (or S) hermetically sealed by the globe 6 and the decompression is carried out, the thermal radiation property of the light-emitting module 2 can be enhanced, the light output of the LED lamp 1 can be sufficiently enhanced, and a desired luminous intensity distribution characteristic can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, it is assumed that the LED lamp 1 is used in a state in which the illustrated posture is reversed, and a capillary processing may be performed so that water is facilitated to spread on the inner surface of the globe 6. That is, thin and long grooves may be formed on the inner surface of the globe 6 so that water collected in the vicinity of the top of the globe 6 is spread on the inner surface of the globe 6 by using the capillary phenomenon, and the water is sucked up to a part where the thermal radiation case 3 is exposed in the enclosed space S2.

What is claimed is:

1. A luminaire comprising:
a light source that generates heat;
a dome inside of which the light source is accommodated, at least part of the dome is translucent or transparent;
a globe covering the light source through the dome, at least part of the globe is translucent or transparent; and
a liquid sealed in a space formed between the dome and the globe.

2. The luminaire according to claim 1, wherein the light source includes a light-emitting diode.

3. The luminaire according to claim 2, wherein a pressure in the space is a pressure at which the liquid vaporizes at 60° C. or higher and 70° C. or lower.

4. The luminaire according to claim 1, wherein the liquid has translucency.

5. The luminaire according to claim 4, wherein the liquid contains water.

6. The luminaire according to claim 1, wherein the dome is made of a light diffusion member, and a top of the dome is arranged at an imaginary center of the globe.

7. A luminaire comprising:
a thermal radiator;
a light-emitting module provided to be capable of conducting heat to the thermal radiator;
a dome inside of which the light-emitting module is accommodated, at least part of the dome is translucent or transparent;
a globe covering the light-emitting module through the dome, at least part of the globe is translucent or transparent; and
a liquid sealed in a space formed between the dome and the globe.

8. The luminaire according to claim 7, wherein the space is configured to have a pressure lower than an external pressure at time of use of the luminaire.

9. The luminaire according to claim 7, wherein the light-emitting module includes a light-emitting diode.

10. The luminaire according to claim 9, wherein a pressure in the space is a pressure at which the liquid sealed in the space vaporizes at 60° C. or higher and 70° C. or lower.

11. The luminaire according to claim 7, wherein the liquid has translucency.

12. The luminaire according to claim 11, wherein the liquid contains water.

13. The luminaire according to claim 7, wherein the dome hermetically seals the light-emitting module, and the light-emitting module is under 101,325 Pa.

14. The luminaire according to claim 7, wherein the dome is made of a light diffusion member, and a top of the dome is arranged at an imaginary center of the globe.

15. A lighting method, comprising:
supplying electric power to a light source to cause the light source to emit light;
vaporizing a liquid sealed in an enclosed space, which is isolated from the light source and is in a vicinity of the light source, by heat generated by light emission; and
suppressing a temperature rise of the light source by using heat of vaporization of the liquid.
